(19) United States
(12) Patent Application Publication
(10) Pub. No.: US 2016/0275590 A1
(43) Pub. Date: Sep. 22, 2016

(54) ALTERNATE PRODUCT RECOMMENDATIONS

(71) Applicant: EBAY, INC, San Jose, CA (US)

(72) Inventor: Michael Charles Todasco, Santa Clara, CA (US)

(21) Appl. No.: 14/661,799

(22) Filed: Mar. 18, 2015

(51) Int. Cl. G06Q 30/06; G06Q 30/00

(52) U.S. Cl. CPC G06Q 30/0631; G06Q 30/016

(57) ABSTRACT

There are provided systems and methods for providing alternate product recommendations for one or more users. A user may enter a merchant location or access a merchant service and be presented with one or more alternate product recommendations. The alternate product recommendations may be provided when a service provider server determines that the user is likely to by a certain product and that the user is also likely to return that product. The alternate product recommendations may present the user with a different purchase opportunity, whether different in kind and/or in price, to avoid or minimize the chances that the user will return the product. The alternate product recommendations may satisfy the user and lower the cost of returns to the merchant.

### TECHNICAL FIELD

Embodiments disclosed herein are related to systems and methods for providing alternate product recommendations for a user based on a product return probability.

### BACKGROUND

In order to ensure customer satisfaction, many retailers provide a return window in which a customer who is not satisfied with a purchased product or service can return the product and/or or request a full or partial refund. In some instances, a minimum product return window may be mandated by state or local consumer protection laws. While generosity with return windows and return policies generally may generate good will with consumers, the returns may provide significant drawbacks for the retailer. For example, when a return is received there is a change in reported revenues for the retailer. Similarly, there are costs associated with the handling of each return as the return must be processed by an employee and the returned product may have decreased resale value in view of the return. Accordingly, the current approaches to handling product returns and refund requests have not been satisfactory in all respects.

### BRIEF DESCRIPTION OF THE FIGURES

FIG. 1 is a block diagram of a networked system, consistent with some embodiments.

FIG. 2 is a diagram illustrating a computing system, consistent with some embodiments.

FIG. 3 is a diagram illustrating a flow of providing alternate product recommendations, consistent with some embodiments.

FIG. 4 is a diagram illustrating another flow of providing alternate product recommendations, consistent with some embodiments.

FIG. 5 is a flowchart illustrating a process for alternate product recommendations, consistent with some embodiments.

In the drawings, elements having the same designation have the same or similar functions.

### DETAILED DESCRIPTION

In the following description specific details are set forth describing certain embodiments. It will be apparent, however, to one skilled in the art that the disclosed embodiments may be practiced without some or all of these specific details. The specific embodiments presented are meant to be illustrative, but not limiting. One skilled in the art may realize other material that, although not specifically described herein, is within the scope and spirit of this disclosure.

There is a need for providing retailers with information and recommendations to avoid or minimize chances of returns even where the retailers have a customer return policy. By avoiding or minimizing chances of returns, the retailer may avoid or reduce the costs of those returns. However, the returns should be avoided in a way that continues to satisfy the customer, thereby maintaining the good will of the customer. If it could be known in advance that a given customer is going to or likely to return a given product, the costs of the return could be avoided or minimized by guiding the customer to a different product or delaying a purchase that will satisfy the customer and that the customer will not return. While ex ante knowledge is elusive, information may be created or may be available that can provide an estimated probability of a product return for a given customer. Consistent with this disclosure, information is processed to generate an alternate product recommendation for a customer that may be considering a first product.

Depending on the product being sold, the product may be part of a line of products that is being updated with some regularity. While many product examples may be used and the principles of this disclosure are widely applicable, an example using smartphone products is provided herein. For example, a company selling smartphones may provide an “updated” smartphone on a regular basis. For example, Samsung Electronics of Suwon, South Korea sells several different smartphones, including a smartphones with a GALAXY S trademark and other smartphones with a GALAXY NOTE trademark. Apple, Inc. of Cupertino, Calif., USA also sells large numbers of smartphones under the IPHONE trademark. These smartphones, or other products in other examples, may be refreshed on a regular or irregular basis. For example, a new smartphone product may be sold under the GALAXY S mark in an iterative manner, e.g., a GALAXY S5 smartphone may be introduced by Samsung Electronics some time after the introduction of a GALAXY S4 smartphone. The smartphone that is second in time may be considered a refreshed or updated product. One or more components of the second-in-time smartphone may have improved functioning or features. For example, a central processor of the GALAXY S5 smartphone may have a higher clock speed or a more efficient architecture compared to a central processor of the GALAXY S4 smartphone. Because the GALAXY S5 smartphone includes improvements over the GALAXY S4, the GALAXY S4 smartphone may be considered less desirable to some consumers after the introduction of the GALAXY S5 smartphone to the market. Generally, the introduction to the market place of a refreshed version of a product that has been available on the market for some time can decrease the value to certain consumers of the unrefreshed product.

Different consumers or different customer segments may respond differently to the introduction of a refreshed product, such as a new version of a company's smartphone. For example, some consumers place significant value on having a most current version of a product, such as a smartphone or article of clothing. Other consumers may not be as concerned about the “newness” of a given product” and may be more concerned about the price of the product after certain benchmark requirements are satisfied. If a consumer has purchased a first version product and a refreshed version of the product is released within the product return window, the consumer's personal preferences may dictate the consumer's response. The consumer that places significant value on having the most recent version of the product may be likely to return the first version of the product and then buy the refreshed version. The retailer that sold the first version of the product to the consumer will incur costs associated with the return. The consumer that places relatively less value on having the most recent version of the product may or may not return the first version of the product. If the consumer does not return the first version of the product, the consumer may feel that the retailer that sold the first version of the product did not provide full value to the consumer in light of the subsequent refreshed version of the product. On the other hand, that consumer may still return the product because the price of the first version of the product may drop after the refreshed product is introduced and then buy the first version of the product at a lower price. This second purchase may be from a different retailer, causing the first retailer to lose the sale.

Thus, depending on the preferences of a particular consumer, the consumer may be more or less likely to return a first version of a product when a refreshed version is introduced to the marketplace. By understanding the preferences of the particular consumer, a retailer may provide guidance to the consumer to wait for the refreshed version of the product to buy the refreshed version or the older version or to buy a different, competing product that has more recently been refreshed. This different competing product may be manufactured or designed by the same company or by a different company. The products may be directly competing products such as smartphones having the same size screen or indirectly competing products such as smartphones having substantially different sized screens. Markets may identify what products are considered to be directly competing. Guiding the particular consumer to buy a different competing product may be referred to as “upselling,” and may be beneficial to the consumer and to the retailer. As discussed herein “upselling” may include selling a different product in addition to selling a more expensive product. Herein, a subsequent version of device and a device intended by its manufacturer to supplant an earlier product may be referred to as refreshed products.

Consistent with some embodiments, there is provided a system for providing alternate product recommendations. The system includes a transaction recommendation module, a database stored to a non-transitory memory that comprises a history of product returns and contextual information of product returns, and a network interface component to receive at least the identity of the user from the merchant-location device, which may be a merchant server or point-of-sale device at a merchant location or a merchant server that executes an online store or marketplace. The transaction recommendation module provides one or more alternate product recommendations, or alternate transaction recommendations, and includes at least one hardware processing device that determines a product return probability for a first product and determines an alternate product recommendation for a user that is likely to be interested in purchasing the first product. The identity of the user is obtained through a wireless communication between a client computing device of the user and a merchant-location device. The merchant-location device transmits at least the identity of the user to the transaction recommendation module over a network.

Consistent with some embodiments, there is provided a system for providing alternate product recommendations. The system includes a transaction recommendation module, a database stored to a non-transitory memory that comprises a history of product returns and contextual information of product returns, and a network interface component that receives at least the identity of the user from the wireless beacon and that transmits the alternate product recommendation for the user to a merchant-location device of a merchant. The transaction recommendation module includes at least one hardware processing device that determines an alternate product recommendation for a user that is likely to be interested in purchasing a first product. An identity of the user is obtained through a wireless communication between a client computing device of the user and a wireless beacon. And the wireless beacon transmits at least the identity of the user to the transaction recommendation module over a network;

Consistent with some embodiments, there is provided a method for providing one or more alternate product recommendations. The method includes steps or operations of receiving an identity of a user from a first device at a service provider server, the first device located at a merchant location, determining a product that the user is likely to purchase, determining, by a processing device of the service provider server, an alternate product recommendation for the user based on at least the identity of the user, and communicating the alternate product recommendation to a device at the merchant location.

Embodiments consistent with this disclosure may allow a merchant to receive an alternate product recommendation for a specific consumer based on information about that consumer. In some embodiments, the consumer may also receive an alternate product recommendation upon entering a retailer's location.

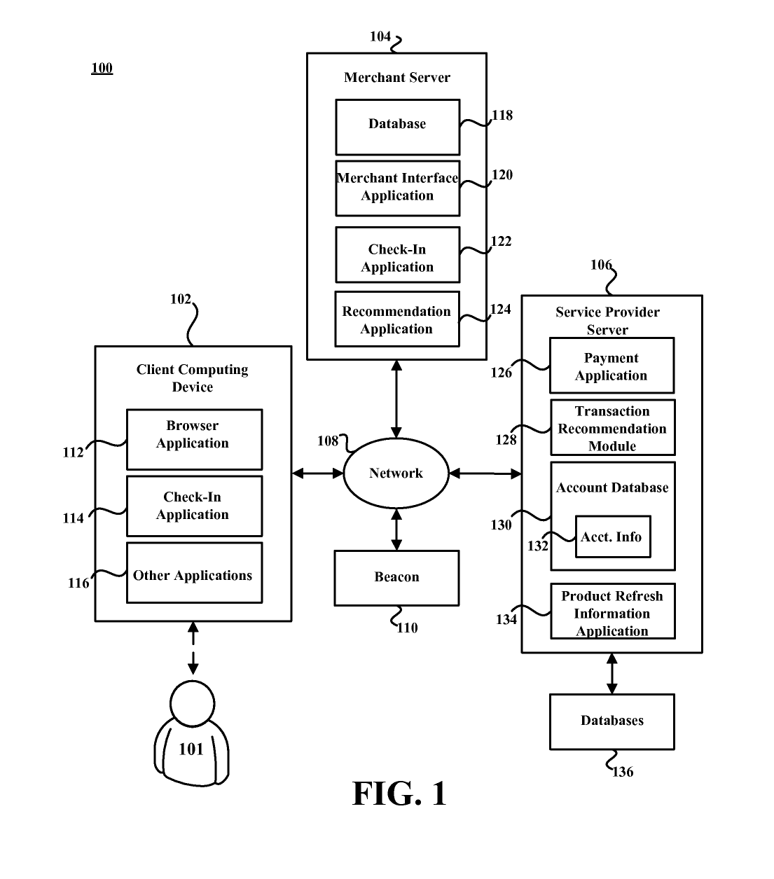

FIG. 1 is a block diagram of a networked system 100, consistent with some embodiments. System 100 includes a client computing device that is referred to herein as a client device 102, a merchant server 104, and a remote service provider server 106 in communication over a network 108. In the illustrated embodiment of the network system 100, the system 100 also includes a wireless beacon 110; other embodiments may include many beacons 110. Both the merchant server 104 and the wireless beacon 110 are referred to as merchant-location devices. At least the wireless beacon 110 is disposed within a merchant's location, such as a retailer store, etc. A customer 101 may be communicating with merchant server 104 and/or service provider server 106 over network 108 using client computing device 102. The client device 102 of the customer 101 may also be communicating with the merchant server 104 over network 108 and with the wireless beacon 110.

In some embodiments, beacons 110 may be Bluetooth™ Low Energy (BLE) beacons. BLE is a technology that transmits information at a frequency of about 2.4 GHz (about 2042-2480 MHz) over forty 2-MHz wide channels, and has a range of about 50 meters or about 160 feet. Information transmitted according to the BLE protocol may be transmitted at a rate of about 1 Mbit/s with an application throughput of about 0.27 Mbit/s. In some embodiments, BLE communications may be secured using 128-bit Advanced Encryption Standard (AES) encryption with counter mode with a cipher block chaining message authentication code (CBC-MAC) and user defined security. Further, in some embodiments, BLE communications may utilize adaptive frequency hopping, lazy acknowledgement, a 24-bit cyclic redundancy check (CRC), and 32-bit message integrity check for robustness. Moreover, in some embodiments, BLE-capable devices may consume a fraction of the power of standard Bluetooth® devices due to the protocol allowing low duty cycles, and being designed for applications that may not require continuous data transfer. Beacons 110 may transmit one or more sequences of information such that when a device such as client computing device 102 capable of receiving information from beacons 110 comes within the range of a beacon 110, such as within a merchant location in which the beacon 110 is installed, the device may receive a transmission from a beacon 110 and be instructed to perform an action, such as display an advertisement, execute a payment application, or check a customer 101 in to a particular location. Beacons 110 may also be capable of receiving one or more sequences of information according to the BLE communications protocol from client computing device 102. In some embodiments, beacon 110 may be in communication with service provider server 106 over network 108 through wireless or wired connection. In other embodiments, beacons 110 may be capable of sending and receiving information according to other wireless communications protocols, such as Wi-Fi™ , ZigBee®, ANT or ANT+, radio frequency identification (RFID), and other such protocols that have a limited range capable of localizing customer 101 to a predetermined proximity in which an advertisement or notification can be presented to the customer 101.

Service provider server 106 may be a payment service processor or other service provider server that may be maintained by a payment processor or other service provider, such as PayPal, Inc. of San Jose, Calif. Service provider server 106 may be maintained by other service providers in different embodiments.

Network 108, in one embodiment, may be implemented as a single network or a combination of multiple networks. For example, in various embodiments, network 108 may include the Internet and/or one or more intranets, landline networks, wireless networks, and/or other appropriate types of communication networks. In another example, network 108 may comprise a wireless telecommunications network (e.g., cellular phone network) adapted to communicate with other communication networks, such as the Internet.

Client computing device 102 may be a mobile device such as a smartphone, a tablet computer, a laptop or netbook, and the like. Client computing device 102 may also be a personal computer, a set-top box (STB) such as provided by cable or satellite content providers, a video game system console, or a smart or internet-enabled television, in some embodiments. Client computing device 102 may also be a head-mounted display (HMD) or other wearable computing device. In some embodiments, client computing device 102 may be implemented in an automobile, for example in an entertainment center or console of an automobile, or is included or implemented in a healthcare device. Client computing device 102 may be implemented using any appropriate combination of hardware and/or software configured for wired and/or wireless communication over network 108.

Consistent with some embodiments, client computing device 102 may include any appropriate combination of hardware and/or software having one or more processing devices, such as a microcontroller or a processor, and capable of reading instructions stored on a non-transitory machine-readable medium or a non-transitory memory for execution by the one or more processing devices. Consistent with some embodiments, client computing device 102 includes a machine-readable medium, such as a memory (not shown) that includes instructions for execution by one or more processors (not shown) for causing client computing device 102 to perform specific tasks. Some common forms of machine-readable media includes, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, and/or any other medium from which one or more processors or computer is adapted to read. Instructions stored on the machine-readable media may include instructions for authenticating client computing device 102 to service provider server 106 to access services provided by service provider server 106, to provide information about the user 101 (also referred to herein as the customer 101) to the merchant server and/or service provider server 106, and/or conducting transactions with service provider server 106 for the generation and communication of alternate product recommendations provided either to the client device 102 of the user 101 or to the merchant server 104.

Such instructions may include instructions for displaying content by particular applications or “apps” stored in a memory of client computing device 102 and executed by one or more processing devices executing in client computing device 102. Example applications include a browser application 112 that displays content, such as a web page or a user interface using a browser, a check-in application 114 that may be used in conjunction with service provider server 106 to provide information to the user 101 about products available from the merchant and/or to provide the merchant server with information about products that the user 101 may be interested in. The products, whether goods or services, may be purchased from a merchant having a physical storefront or a digital storefront that is represented by merchant server 104. Browser application 112 may be implemented as a web browser to view information available over network 108. Browser application 112 may include instructions executable by one or more processors for interfacing and communicating with service provider server 106, a merchant interface provided by merchant server 104, or other servers managed by content providers or merchants via network 108. For example, customer 101 may be able to access websites using browser 112 to find and purchase items from merchant server 104 through a payment service provider provided by service provider server 106, such as PayPal, as well as access user account information or web content. In some embodiments, customer 101 may be able to use the check-in application 114 to check into a retailer location or online store and to pay for items, with the payments being processed by service provider server 106. In some embodiments, check-in application 114 may be able to interact with merchant server 104 and/or service provider server 106 to trigger the generation of an alternate product recommendation to be presented to the customer 101.

Other applications 116 may be desired in one or more embodiments to provide additional features available to customer 101, including accessing a user account with service provider server 106. For example, other applications 116 may include interfaces and/or communication protocols that allow the user to receive and transmit information through network 108 and to service provider server 106 and other online sites. Other applications 116 may also include security applications for implementing client-side security features, programmatic client applications for interfacing with appropriate application programming interfaces (APIs) over network 108 or various other types of generally known programs and/or applications. Other applications 116 may include mobile apps downloaded and resident on client computing device 102 that enable customer 101 to access content through the apps.

Merchant server 104 may be maintained, for example, by a merchant or seller offering various items in exchange for payment. In some embodiments, the payments may be received over network 108. In some embodiments, merchant server 104 may be in communication with a point-of-sale (POS) device maintained by the merchant in a physical storefront; the POS device may also be referred to as a merchant-location device. In some embodiments, the merchant server 104 is the POS device. Merchant server 104 may also include a database 118 identifying available items which may be made available for viewing and purchase by customer 101. The database 118 may identify the available products that are present at the merchant location and may identify products that are available at other merchant locations or at a merchant operating warehouse. Database 118 may include descriptions, images, and pricing of the products. Merchant server 104 may also include a merchant interface application 120 which may be configured to serve information over network 108 to browser application 112 and/or check-in application 114 of client computing device 102. In some embodiments, customer 101 may interact with merchant interface application 120 through browser application 112 over network 108 in order to view various products, food items, or services identified in database 118.

Merchant server 104 also includes a check-in application 122 which may be configured to communicate with the beacon 110 to receive check-in information from the check-in application 114 of the client device 102. The check-in information may include an identity of the user 101 such that the identity of the user 101 is known to the merchant 104. For example, after a check-in is performed on the arrival of the user 101 at the merchant location, the merchant may receive notice that the user 101 is present. The merchant may be presented with specific information regarding the user 101 such as recent purchases with the merchant, purchases with other merchants, demographic information, products that are likely to interest the user 101, etc. Some of this information may be received from the client device 102 after performing the check-in. In some embodiments, after the check-in is performed, the check-in application 122 communicates with the service provider server 106, which then provides the information to the merchant server 104. In some instances, the check-in is performed between the client device 102 and the service provider server 106 through the beacon 110, without intermediation by the merchant server 104, which then receives information about the user 101 of the client device 102 from the service provider server 106.

Merchant server 104 may also include a recommendation application 124. In some embodiments, the recommendation application 124 may be capable of receiving one or more alternate product recommendations from the service provider server 106 based on information about the user 101 or the customer 101 to avoid making a sale of a product to the customer 101 that the customer 101 is likely to return. The recommendation application 124 may also be capable of requesting the alternate product recommendations for the customer 101 when the customer 101 checks into the merchant location. In some embodiments, the recommendation application 124 may receive information about the customer 101 from the client device 102, the service provider server 106, and/or its database 118 and use that information to calculate a return probability for a product that the customer 101 is likely to buy from the merchant and to determine an alternate product recommendation that is likely to satisfy the desires of the customer 101 and avoid a subsequent return of purchased product, whether the product the customer 101 is determined likely to buy or another product. In some embodiments, such calculations and determination are made by the service provider server 106, which then provides the alternate product recommendation to the merchant server 104 and/or the client device 102.

Service provider server 106, according to some embodiments, may be maintained by an online payment provider or other service provider, such as PayPal, Inc. of San Jose, Calif., which may provide processing for information to generate alternate product recommendations for the customer 101. In some embodiments, service provider server 106 may include payment application 126, which may be adapted to interact with client device 102 and merchant server 104 to process payments to be made by service provider server 106 for items purchased by customer 101 using client device 102, including items purchased from the merchant location using the merchant server 104. Service provider server 106 may also include a transaction recommendation module 128. In some embodiments, transaction recommendation module 128 may be capable of receiving information about the customer 101. The transaction recommendation module 128 receives the information about the customer 101 and about products available to the customer 101 from the merchant that operates the merchant server 104 and generates an alternate product recommendation. Some of the information may be received from the client device 102, and some of the information may be received from other sources. Some of the information received by transaction recommendation module 128 may be stored locally in account database 130.

Account database 130 may include one or more databases, each of which may include account information 132 associated with individual users. For example, account information 132 may include private financial information of users of service provider server 106 such as account numbers, credentials, passwords, device identifiers, user names, phone numbers, credit card information, bank information, purchase histories, or other financial information which may be used to facilitate online transactions by customers and to generate alternate product recommendations for customers. Account information 132 may also include purchase history of each customer including customer 101, including a listing of goods and services purchased, a date and time of purchase, a price paid, and a merchant and or merchant location associated with each purchase. The account information 132 may further include an entry or entries including a payment history of customers, past amounts paid by customers that were processed by service provider server 106, and demographic and product preference information of the customers. The account information 132 may include information about each customer that originated with another service provider and was acquired from that service provider by the operator of the service provider server 106. The acquired information may allow the transaction recommendation module 128 to provide alternate product recommendations that are more desirable to the customers than if the acquired information was not used.

The service provider server 106 further includes a product refresh information application 134 that provides information to the transaction recommendation module 128 regarding confirmed or rumored product refreshes. The product refresh information application 134 may be a web crawler programmed to crawl to specific sites, or to identify websites of interest and crawl them, and parse text found on the websites to identify product refresh information. For example, many technology rumor sites are present on the Internet that include posts, articles, or messages that include speculation or confirmed information regarding an impending product refresh. Social media web sites and Internet-based social sharing services may also be monitored for product refresh information. Industry analysts may provide information from contacts in the industry that can be used to provide information dating either approximately or precisely the product refresh. When the product refresh information application 134 identifies a candidate for a product refresh, the transaction recommendation module 128 may compare the identified product refresh date with the product return window of an associated competing product. In some embodiments, the product refresh information application 134 may parse a database present within the databases 136 to identify manually entered product refresh information. For example, the databases 136 may include a database of contextual information that includes context of a plurality of product returns. The contextual information may include dates, weather conditions, location, account balances, people accompanying a customer at the time and purchase, and/or at the time of the return, etc. The contextual information may include a history of product returns by an individual customer and may include large amounts of returns data for a plurality of customers that is not able to be broken down by individual customers.

Additionally, the transaction recommendation module 128 may implement one or more machine learning algorithms to identify conditions or events that correlate with a product return probability for a given product such as a product refresh or a new product introduction. Similarly, the service provider server 106 may determine a most suitable alternate product recommendation from among a plurality of potential alternate product recommendations for a particular customer. In embodiments in which the alternate product recommendation is provided to the merchant by communicating the alternate product recommendation to the merchant server 104, the merchant server 104 may manipulate a user interface to select, from among the plurality of alternate product recommendations, an alternate product recommendation that is most preferable to the merchant. The merchants may release the selected alternate product recommendation to be communicated from the merchant server 104 to the client device 102 or from the service provider server 106 to the client device 102.

Service provider server 106 may also include other applications and one or more additional databases 136 that may store additional information for use by service provider server 106. One or more of the additional databases 136 may be operated by the operator of the service provider server 106. In some embodiments, the operator of the service provider server 106 may purchase access to a database of customer information that may then be accessed by the service provider server 106 over a network, such as the network 108. The quantities and types of data that may be used in generating the alternate product recommendations are immense. In addition to information regarding the individual customer 101, the service provider server 106 may incorporate information such as weather patterns seasonal purchase patterns and other patterns that may be gleaned from large data sets. Because the service provider server 106 can include information from merchant servers belonging to many different merchants at many different merchant locations, additional insights may be obtained by algorithmic assessment of the corresponding agglomerated data set.

Although discussion has been made of applications and applications on client device 102, merchant server 104, service provider server 106, and the beacon 110, the applications may also be, in some embodiments, modules. Module, as used herein, may refer to a software module that performs a function when executed by one or more processing devices or Application Specific Integrated Circuit (ASIC) or other circuit having memory and at least one processor for executing instructions to perform a function, such as the functions described as being performed by the applications.

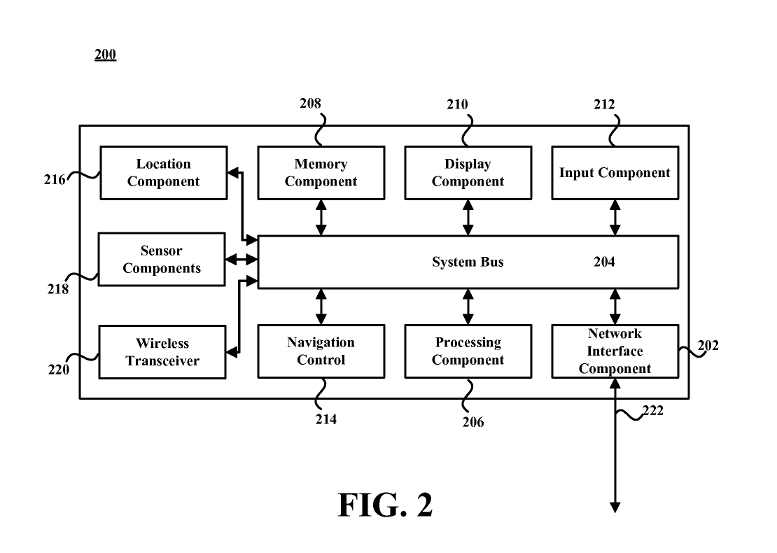

FIG. 2 is a diagram illustrating computing system 200, which may correspond to either of client computing device 102, merchant server 104, service provider server 106, or beacon 110 consistent with some embodiments. Computing system 200 may be a mobile device such as a smartphone, a tablet computer, a personal computer, laptop computer, netbook, or tablet computer, set-top box, video game console, head-mounted display (HMD) or other wearable computing device as would be consistent with client computing device 102. Further, computing system 200 may also be a server or one server amongst a plurality of servers, as would be consistent with merchant server 104 and service provider server 106. As shown in FIG. 2, computing system 200 includes a network interface component (NIC) 202 configured for communication with a network such as network 108 shown in FIG. 1. Consistent with some embodiments, NIC 202 includes a wireless communication component, such as a wireless broadband component, a wireless satellite component, or various other types of wireless communication components including radio frequency (RF), microwave frequency (MWF), Bluetooth Low Energy (BLE), and/or infrared (IR) components configured for communication with network 108. Consistent with other embodiments, NIC 202 may be configured to interface with a coaxial cable, a fiber optic cable, a digital subscriber line (DSL) modem, a public switched telephone network (PSTN) modem, an Ethernet device, and/or various other types of wired and/or wireless network communication devices adapted for communication with network 108.

Consistent with some embodiments, computing system 200 includes a system bus 204 for interconnecting various components within computing system 200 and communicating information between the various components. Such components include a processing component 206, which may be one or more processors, micro-controllers, graphics processing units (GPUs) or digital signal processors (DSPs), and a memory component 208, which may correspond to a random access memory (RAM), an internal memory component, a read-only memory (ROM), or an external or static optical, magnetic, or solid-state memory. Consistent with some embodiments, computing system 200 further includes a display component 210 for displaying information to a user 101 of computing system 200. Display component 210 may be a liquid crystal display (LCD) screen, an organic light emitting diode (OLED) screen (including active matrix AMOLED screens), an LED screen, a plasma display, or a cathode ray tube (CRT) display. Computing system 200 may also include an input component 212, allowing for a user of computing system 200, such as customer 101, to input information to computing system 200. Such information could include payment information such as an amount required to complete a transaction, account information, authentication information such as a credential, or identification information. An input component 212 may include, for example, a keyboard or key pad, whether physical or virtual. Computing system 200 may further include a navigation control component 214, configured to allow a user to navigate along display component 210. Consistent with some embodiments, navigation control component 214 may be a mouse, a trackball, or other such device. Moreover, when system 200 includes a touch screen, display component 210, input component 212, and navigation control 214 may be a single integrated component, such as a capacitive sensor-based touch screen.

Computing system 200 may further include a location component 216 for determining a location of computing system 200. In some embodiments, location component 216 may correspond to a GPS transceiver that is in communication with one or more GPS satellites. In other embodiments, location component 216 may be configured to determine a location of computing system 200 by using an internet protocol (IP) address lookup, or by triangulating a position based on nearby telecommunications towers or wireless access points (WAPs). Location component 216 may be further configured to store a user-defined location in memory component 208 that can be transmitted to a third party for the purpose of identifying a location of computing system 200. Computing system 200 may also include sensor components 218. Sensor components 218 provide sensor functionality, and may correspond to sensors built into client computing device 102 or sensor peripherals coupled to client computing device 102. Sensor components 218 may include any sensory device that captures information related to customer 101 and/or client computing device 102 that may be associated with any actions that customer 101 performs using client computing device 102. Sensor components 218 may include camera and imaging components, accelerometers, biometric readers, GPS devices, motion capture devices, and other devices that are capable of providing information about client computing device 102 or customer 101, or an environment therearound. Computing system 200 may also include one or more wireless transceivers 220 that may each include an antenna that is separable or integral and is capable of transmitting and receiving information according to one or more wireless network protocols, such as Wi-Fi™, 3G, 4G, HDSPA, LTE, RF, NFC, IEEE 802.11a, b, g, n, ac, or ad, Bluetooth®, BLE, WiMAX, ZigBee®, etc.

Computing system 200 may perform specific operations by processing component 206 executing one or more sequences of instructions contained memory component 208. In other embodiments, hard-wired circuitry may be used in place of or in combination with software instructions to implement the present disclosure. Logic may be encoded in a computer readable medium, which may refer to any medium that participates in providing instructions to processing component 206 for execution, including memory component 208. Consistent with some embodiments, the computer readable medium is tangible and non-transitory. In various implementations, non-volatile media include optical or magnetic disks, volatile media includes dynamic memory, and transmission media includes coaxial cables, copper wire, and fiber optics, including wires that comprise system bus 204. According to some embodiments, transmission media may take the form of acoustic or light waves, such as those generated during radio wave and infrared data communications. Some common forms of computer readable media include, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, carrier wave, or any other medium from which a computer is adapted to read.

In various embodiments of the present disclosure, execution of instruction sequences to practice the present disclosure may be performed by computing system 200. In various other embodiments of the present disclosure, a plurality of computing systems 200 coupled by a communication link 222 to network 108 (e.g., such as a LAN, WLAN, PTSN, and/or various other wired or wireless networks, including telecommunications, mobile, and cellular phone networks) may perform instruction sequences to practice the present disclosure in coordination with one another. Computing system 200 may transmit and receive messages, data and one or more data packets, information and instructions, including one or more programs (i.e., application code) through communication link 222 and network interface component 202 and wireless transceiver 220. Received program code may be executed by processing component 206 as received and/or stored in memory component 208.

Customers, such as customer 101, may enter a merchant location with the intent to purchase a specific product or in order to browse or learn more about the products available at the merchant location. In some instances, when the customer 101 enters the merchant location and the customer is checked into the location by the merchant server 104 or by the service provider server 106 through the beacon 110 or directly over the network 108, the transaction recommendation module 128 receives the identity of the customer 101 and collects information about the customer 101, such as the purchase history of customer 101. Based on that information and information about the merchant location, such as the products offered at the merchant location, the transaction recommendation module 128 may identify a product that the customer 101 is likely to be interested in. This identification may be a probabilistic identification, such that for the identified product it is true for a certain subset of customers in a large set of customers that the subset of customers is interested in buying the product. For example, the purchase history of the customer 101 may indicate that the customer 101 has purchased a new smartphone every year during the month of October for two years. The transaction recommendation module 128 may use that information, information indicating that the current date falls in October or falls within a window around October, information indicating that the current inventory of the merchant location (as stored in the database 118 on the merchant server 104) includes smartphones to predict that the customer 101 is likely to be interested in a new smartphone.

This customer 101 may be identified in the account information 132 as a customer that places a priority on newness of certain products, indicating that the customer 101 is more interested than the average customer in having a new product within at least some product categories. In this example in which the customer 101 has purchased a new smartphone each year for two years, these purchases indicate that the customer 101 is interested in having a new smartphone. Additional or alternative factors may be extracted from the information available to the transaction recommendation module 128 to indicate that the customer 101 is interested in having the most recent version of a product. Demographic factors, such as education level, annual income, residence, etc. may indicate such a characteristic as well as prior purchase history.

For example, when the customer 101 enters the merchant location, the transaction recommendation module 128 may determine that the customer 101 is interested in a new smartphone. The transaction recommendation module 128 may also access product information from the databases 136 about smartphones, including the availability of new models. For example, the service provider server 106 may include a web crawler, provided by the product refresh information application 134, that searches content on the internet, such as technology focused sites, for information describing a rumored or confirmed release date for a new product. For example, a site may be crawled and the text found thereon may be parsed to identify such information. In some embodiments, a database may be maintained by the service provider server 106 with such new product release information or information regarding refreshes to existing products. Additionally, the transaction recommendation module 128 may receive information from the merchant server 104 regarding a return window applicable to one or more products sold by the merchant. The transaction recommendation module 128 may compare the return window with information that indicates that a product will soon be refreshed. For example, the transaction recommendation module 128 may determine that a new product that may be of interest to the consumer 101 will be released within the return window.

Using such information, the transaction recommendation module 128 may calculate a product return probability for the product. In some embodiments the transaction recommendation module 128 may calculate a product return probability specifically for the customer 101 based on information about the customer 101. In other embodiments, the transaction recommendation module 128 may calculate a product return probability specific to the product as sold by the merchant. The transaction recommendation module 128 may determine an alternate product recommendation for the customer 101. The alternate product recommendation may be provided to the customer 101 either directly by the client computing device 102 or by way of an employee working at the merchant location. For example, the employee may receive the alternate product recommendation by way of the merchant server 104 and then communicate the ultimate product recommendation to the customer 101.

The alternate product recommendation is a recommendation intended to satisfy the customer and avoid a product return in order to avoid the costs associated with the return. For example, the transaction recommendation module 128 may calculate or receive a calculation describing the costs of returning the product that the transaction recommendation module 128 has determined the customer 101 is likely to be interested in purchasing. The transaction recommendation module 128 may be a recommendation to purchase a competing product. For example, if the customer 101 is determined by the transaction recommendation module 128 is likely being interested in buying a smartphone A from company B, the alternate product recommendation may be to buy a smartphone Y from company Z. This recommendation may be provided to the customer 101 so that the merchant may avoid the cost of returning the smartphone A when a refreshed version of the smartphone A is released during the return window. The smartphone Y may be a newer model smartphone, such that the customer 101 is still likely to be satisfied with the smartphone Y even after the refreshed version of the smartphone A is released.

As another example, the transaction recommendation module 128 may generate an alternate product recommendation providing a discount to the customer 101 if the customer 101 purchases the unrefreshed smartphone A. Because of the discount received by the customer 101, the customer 101 may feel that he or she received adequate value even after the refreshed smartphone A is released. The ultimate product recommendation may provide a discount that is similar to the cost of processing the return of the unrefreshed smartphone A by the customer 101. For example, the alternate product recommendation may be presented as a coupon that has a value that is less than the cost of processing the return of the unrefreshed smartphone A.

As yet another example, the transaction recommendation module 128 may generate an ultimate product recommendation providing a discount to the customer 101 if the customer 101 returns after the release of the refreshed smartphone A to purchase the refreshed smartphone A at a later date. By providing such an alternate product recommendation, the merchant may earn the goodwill of the customer 101 by informing the customer 101 of the impending refresh of the smartphone A and the merchant may provide an incentive to the customer 101 to return to the merchant to purchase the refreshed smartphone A at after the release of that product. These and other alternate product recommendations may decrease the number of product returns that the merchant has to process and may increase customer satisfaction.

In another example, a determination may be made, such as based on previous purchases and search history, that the customer 101 is likely to return an unrefreshed product and purchase a refreshed product only if there are certain improvements to the refreshed product. For example, the customer 101 may only be interested in the higher priced refreshed product if it is smaller, weighs less, has more processing power, has a larger screen, is more resistant to water, has a higher resolution camera, is not more than a certain dollar or percentage amount from the unrefreshed product, etc., or a specific combination thereof Thus, specific changes between the unrefreshed product and the refreshed product may be used to determine whether a specific customer is more likely to return the unrefreshed product or not.

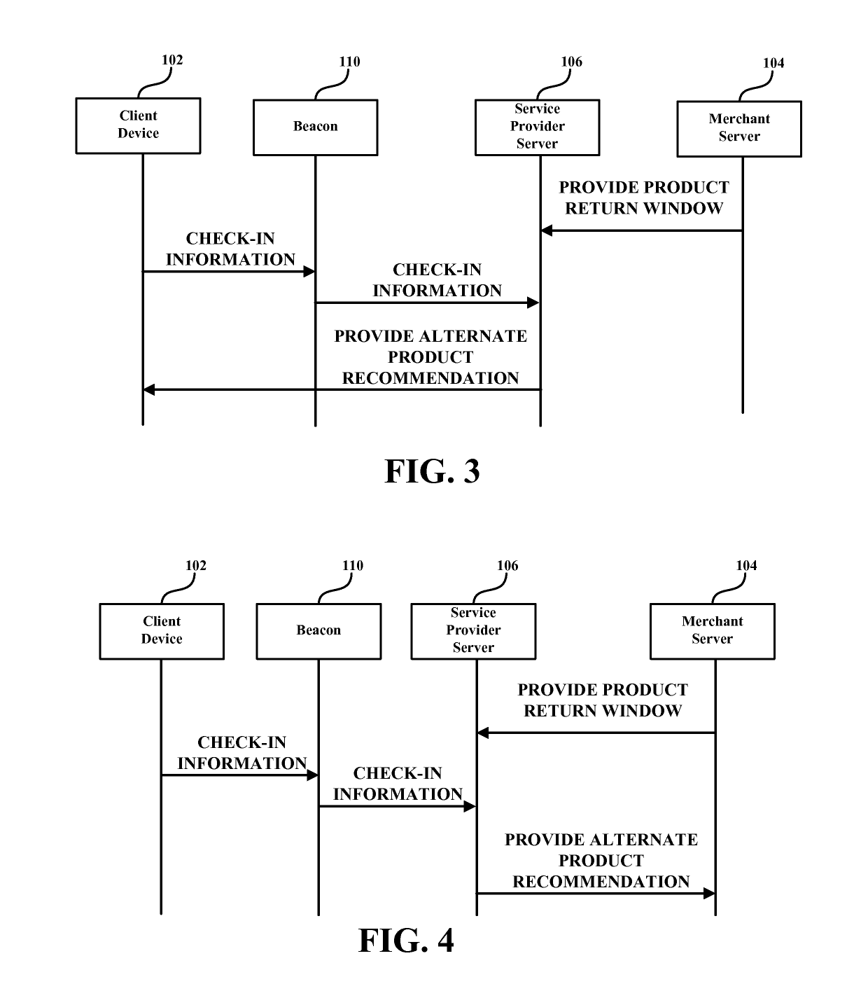

FIG. 3 is a diagram illustrating a flow of providing an alternate product recommendation to the customer 101, consistent with some embodiments. As shown in FIG. 3, when customer 101 arrives at the merchant location check-in information is provided from the client device 102 to the beacon 110. This check-in information is communicated to the service provider server 106 which then completes the check-in of the customer 101. After the check-in of the customer 101 is complete, the service provider server 106 provides an alternate product recommendation to the client device of the customer 101. The merchant server 104 may provide information to the service provider server 106, such as a product return window, with which the service provider server 106 calculates a product return probability for a first product. In some embodiments, this information may be provided prior to the check-in; while in other embodiments, information specific to the first product may be requested from the merchant serve 104 after the service provider server 106 determines one or more products (including the first product) that the customer 101 is likely to buy at the merchant location.

FIG. 4 is another diagram illustrating a flow of providing an alternate product recommendation to the customer 101. Upon arrival at the merchant location, the client device 102 of the customer 101 communicates check-in information with the beacon 110. This check-in information is provided to the service provider server 106 over the network 108 in order for the service provider server 106 to complete a check-in of the customer 101 (i.e., of the client device 102 of the customer 101). After the check-in of the client device 102 is complete, the service provider server 106 estimates from past purchase history, demographic information, search history, and other information (such as advertised sales of the merchant offered at the merchant location) what product the customer 101 is interested in purchasing. The service provider server 106 then calculates a product return probability that indicates the probability that the customer 101 would return the product if the customer 101 were to purchase the product. The product return probability may be specific to the customer 101 or may be a general product return probability to be used in determining alternate product recommendations for many customers. After the product return probability is determined, the service provider server 106 communicates the alternate product recommendation or recommendations to the merchant server 104.

For example, as an alternate product recommendation, the merchant server 104 may receive and process information indicating that the customer 101 should be directed to a competing product. The competing product may be a more expensive product or may be a less expensive product. The competing product may be a different model provided by the same company as the first product. For example, if a customer enters the store and is determined to be likely to purchase a lower tier smartphone from company A, the service provider server 106 may determine that there is likely to be a refresh of the lower tier phone within a product return window of the lower tier smartphone. The service provider server 106 may provide an alternate product recommendation to the merchant server 104, indicating that the customer 101 should be encouraged to buy or provided information regarding a higher tier smartphone made by company A that is not likely to be refreshed within the product return window. In this way, the merchant may avoid the costs of a returned product and may still provide the customer with a satisfying product. The service provider server 106 may provide another recommendation that the customer 101 should wait on purchasing the current smartphone because a newer version of the smartphone will be introduced shortly and the customer 101 is not likely to want to pay the higher price or want the newer features, but instead would prefer to still purchase the current smartphone at a lower price (and can wait) when the refreshed smartphone is introduced.

As part of this flow illustrated in FIG. 4, the merchant server 104 provides information to the service provider server 106, such as the product return window. Some products or services sold by the merchant may be sold with different product return windows. In some embodiments, the merchant server 104 provides this information to the service provider server 106 as the merchant server 104 receives it, or the merchant server 104 may provide regularly scheduled updates to the service provider server 106. In some embodiments, the product return window is requested by the service provider server 106 from the merchant server 104 when the service provider server 106 determines what product or products a check-in customer is likely to be interested in. Additional information from the merchant server 104, such as inventory and scheduled or ongoing sale information (e.g., products on sale and associated sale prices) may be provided to the service provider server 106 in advance of a check-in or at the request of the service provider server 106.

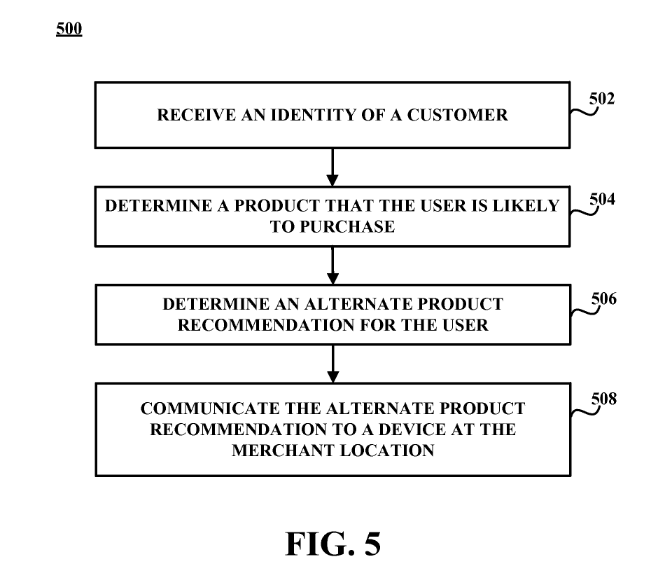

FIG. 5 is a flowchart illustrating a process 500 for providing alternate product recommendations for a customer, consistent with some embodiments. For the purpose of illustration, FIG. 5 may be described with reference to any of FIGS. 1-4. Process 500 shown in FIG. 5 may be embodied in computer-readable instructions for execution by one or more processing devices such that the steps of process 500 may be performed by a service provider server 106 that is associated with a merchant and a merchant server 104. In some embodiments, transaction recommendation module 128 of the service provider server 106 may include instructions for performing one or more steps of process 500. Additionally, the process 500 is illustrated as a series of enumerated steps or operations. Embodiments of the process 500 may include additional steps or operations before, after, in between, or as part of the enumerated steps or operations.

In the embodiment illustrated in FIG. 5, the process 500 may be initiated when an identity of a customer is received from a first device (502). The first device may be the client computing device 102 described herein. The service provider server 106 may receive the identity of the user or customer 101 when the customer enters the merchant location having a beacon device such as the beacon 110. A check-in process is initiated to check-in the customer 101, which identifies the customer 101 to the service provider server 106. As part of the check-in process, the service provider server 106 may retrieve account information 132 associated with the customer 101. This account information may include purchase histories, search histories, demographic information, financial information, and/or other information about the customer 101 that may be used to determine the preferences of the customer 101 regarding refreshed products, unrefreshed products, and specific features of such products.

The service provider server may use the account information associated with the customer 101 to identify at least one product that the user is likely to be interested in purchasing (504). In identifying the at least one product, the service provider server may communicate with the merchant server 1042 receive information regarding inventories at a merchant location or locations and or sale information identifying items or services available for sale at the merchant location or locations. This information may also be used by the service provider server 106 and identifying the at least one product that the user is likely to be interested in purchasing. A product refresh information application 134 may identify refresh information associated with the at least one product. For example, the product refresh information application 134 of the service provider server 106 may determine that the at least one product is to be refreshed within a product return window associated with the merchant and the at least one product. The transaction recommendation module 128 uses this information and information about the customer 101 to calculate a product return probability for the at least one product. The product return probability describes the probability of how likely or unlikely it is that the customer 101 would return the product assuming that the customer 101 were to purchase the product. For example, if the transaction recommendation module 128 determines that the customer 101 values the newness of a product and determines that the product is likely to be refreshed by its manufacturer the product return probability may be high.

When the product return probability is above a threshold value, the transaction recommendation module 128 determines an alternate product recommendation for the customer (506). The transaction recommendation module 128 may base the determination of the alternate product recommendation for the user on at least the identity of the user and the product return probability. In basing the determination of the alternate product recommendation on the identity of the user, the transaction recommendation module 128 may use personal information, financial information, demographic information, etc., of the customer 101. In determining and/or generating the alternate product recommendation, the transaction recommendation module 128 or another component of the service provider server 106 may provide a recommendation that the customer 101 wait until a refreshed product becomes available. For example, the alternate product recommendation may be a coupon that will be valid for the refreshed product after the refreshed product becomes available. In some embodiments, the coupon may be valid only at the store or location in which the customer 101 is checked in. In other embodiments, such a coupon may be valid at any location of the merchant. As another example, the alternate product recommendation may be a recommendation to purchase a competing product that has been refreshed more recently. Since the competing product has been refreshed more recently, the customer 101 may be less likely to return the product after the refreshed version of the product the customer 101 was determined to be likely to buy is released. As yet another example, the alternate product recommendation may be a coupon or discount for the product that the customer 101 was determined to be likely to buy. By offering the discount, the merchant may provide a compensating value to a customer that values newness of products. Because the customer 101 is able to obtain the product at a discount, the customer 101 may perceive that the transaction was advantageous even after the release of a refreshed version of the product.

After the alternate product recommendation or a plurality of alternate product recommendations are generated by the service provider server 106, the service provider server 106 may communicate the ultimate product recommendation or recommendations to a device at the merchant location at which the customer 101 checked in (508). In communicating the alternate product recommendation, the service provider server 106 may communicate it over the network 108 to the client computing device 102. For example, a coupon or discount may be provided to the customer 101 through the check-in application 114 of the client device 102. Alternatively, an advertisement for competing product may be displayed on the client computing device 102 to the customer 101. In other embodiments, the service provider server 106 may communicate the alternate product recommendation or recommendations to the merchant server 104. For example, the service provider server 106 may transmit the recommendation or recommendations over the network 108 to the recommendation application 124. The recommendation application 124 may display the recommendation or recommendations to an employee working at the merchant location. The employee may then approach the customer 101 to discuss and/or offer the alternate product recommendations. In some embodiments, the service provider server may communicate the alternate product recommendation to the merchant server 104, which in turn communicates the alternate product recommendation to the client device 102 and thereby to the customer 101. Accordingly, the alternate product recommendation may be provided to the customer 101 in a variety of ways.

In some embodiments, the client computing device 102 communicates with the merchant server 104 over the network 108. For example, the merchant server 104 may provide a customer-facing online store, through which the customer 101 can purchase items at a specified price or at a negotiated or auction-based price. In some embodiments, the check-in application 114 may communicate with the check-in application 122 to check the customer 101 into the online store, such as by a log on process. The principles described herein may be applied by the merchant server 104 to communicate information to the service provider server 106 and to receive one or more alternate product recommendations from the service provider server 106, which the merchant server 104 may use to visually highlight alternate, competing products in a web-based view of the online store or in an app associated with the merchant operating the merchant server 104, such as the merchant interface application 120. The merchant server 104 may display the alternate, competing product in place of an item that the customer 101 is likely to be checking into the merchant server 104 to buy. The merchant server 104 may additionally or alternatively provide a discount for the product the customer 101 is likely to be interested in purchasing or for the alternate, competing product.

Accordingly, the principles described in connections with FIGS. 3, 4, and 5 may enable an online retailer to provide alternate product recommendations to customers in order to minimize the cost of returns by decreasing the rate of returns. In such embodiments, the customer 101 may not need to be physically present within the merchant location and the client device 102 may not check-in to the merchant server 104 through the beacon 110. Instead the check-in or log-in information may be provided directly from the client device 102 to the merchant server 104. In such embodiments, the merchant server 104 may be understood as a merchant-location device providing the online store to the customer 101.

Software, in accordance with the present disclosure, such as program code and/or data, may be stored on one or more machine-readable mediums, including non-transitory machine-readable medium. It is also contemplated that software and processes realizable as software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein. The use of information about the customer, about the product return window, and about the likelihood or occurrence of a product refresh may be performed as described herein in order to decrease the total costs of returns to merchant and to provide customers with products that they will value. As described, the information may be used to determine whether a customer is likely to return a given product may include information that cannot be analyzed by a human to determine all meaningful correlations that indicate the likelihood of a product return or the likelihood of a product refresh. For example, the service provider server 106 may determine analysis of data that the likelihood that a customer will return a product is unusually high on rainy Tuesday mornings. Accordingly, the service provider server 106 may provide more alternate product recommendations to customer shopping on rate rainy Tuesday mornings then on sunny Saturday afternoons. Accordingly, the service provider server 106 may determine through analysis of massive amounts of data that specific times, weather patterns, specific, seemingly unrelated prior purchases by consumer, and other non-intuitive correlations, indicate an increased likelihood that a purchase of a given product will result in a product return. These correlations may be identified by the service provider server 106 at the level of an individual customer or the level of identified customer categories.

The examples provided above are exemplary only and are not intended to be limiting. One skilled in the art may readily devise other systems consistent with the disclosed embodiments which are intended to be within the scope of this disclosure. As such, the application is limited only by the following claims.

What is claimed is:

1. A system comprising:
a transaction recommendation module comprising at least one hardware processing device that determines an alternate product recommendation for a user that is likely to be interested in purchasing a first product, wherein an identity of the user is obtained through a wireless communication between a client computing device of the user and a wireless beacon, and wherein the wireless beacon transmits at least the identity of the user to the transaction recommendation module over a network;
a database stored to a non-transitory memory that comprises a history of product returns and contextual information of the product returns; and
a network interface component that receives at least the identity of the user from the wireless beacon and that transmits the alternate product recommendation for the user to a merchant-location device of a merchant.

2. The system of claim 1, wherein the alternate product recommendation is a recommendation to purchase a directly competing product.

3. The system of claim 1, wherein the transaction recommendation module calculates a product return probability based on a release date of a second product that is a refreshed product to the first product.

4. The system of claim 3, wherein the alternate product recommendation is specific to the user and is based on information about the user accessed using the identity of the user.

5. The system of claim 3, wherein the alternate product recommendation is further based on a return window, the return window being a period of time in which the first product can be returned to a selling merchant by the user after purchase of the first product.

6. The system of claim 1, wherein the alternate product recommendation is based on a specific feature of a second product that is a refreshed product to the first product.

7. The system of claim 1, wherein the alternate product recommendation for the user is a discount on the first product.

8. The system of claim 7, wherein the discount on the first product is based on a cost of a return of the first product to a merchant having the merchant-location device.

9. The system of claim 1, wherein the network interface component transmits the alternate product recommendation for the user to the client computing device of the user.

10. A system comprising:
a transaction recommendation module comprising at least one hardware processing device that determines a product return probability for a first product and determines an alternate product recommendation for a user that is likely to be interested in purchasing the first product, wherein an identity of the user is obtained through a wireless communication between a client computing device of the user and a merchant-location device, and wherein the merchant-location device transmits at least the identity of the user to the transaction recommendation module over a network;
a database stored to a non-transitory memory that comprises a history of product returns and contextual information of the product returns; and
a network interface component that receives at least the identity of the user from the merchant-location device.

11. The system of claim 10, further comprising a web crawler to identify product refresh information on a website.

12. The system of claim 10, further comprising a wireless beacon in communication with the client computing device of the user and wherein the merchant-location device comprises a point-of-sale terminal in communication with the client computing device through the wireless beacon.

13. The system of claim 10, wherein the alternate product recommendation is a recommendation to purchase a competing product, a recommendation to delay the purchase, or a recommendation to purchase the first product at a discount.

14. The system of claim 10, wherein the transaction recommendation module determines the product return probability based on a release date of a second product that is a refreshed product to the first product.

15. The system of claim 10, wherein the product return probability is specific to the user and is based on information about the user accessed using the identity of the user.

16. A method comprising:
receiving an identity of a user from a first device at a service provider server, the first device located at a merchant location;
determining a product that the user is likely to purchase;
determining, by a processing device of the service provider server, an alternate product recommendation for the user based on at least the identity of the user; and
communicating the alternate product recommendation to a device at the merchant location.

17. The method of claim 16, further comprising performing a check-in between a client computing device of the user and the first device, wherein the first device is a merchant-location device.

18. The method of claim 16, wherein the alternate product recommendation is a recommendation that the user purchase a different product.

19. The method of claim 16, further comprising determining a product return probability is based upon a return window in which the user is permitted to return the product if the user purchases the product.

20. The method of claim 16, further comprising retrieving product preference information associated with the user from a database.
